(19) United States
(12) Patent Application Publication
(10) Pub. No.: US 2010/0070335 A1
(43) Pub. Date: Mar. 18, 2010

(54) Method and System for Targeting Online Ads Using Social Neighborhoods of a Social Network

(76) Inventors: Rajesh Parekh, San Jose, CA (US); Rushi P. Bhatt, Surat (IN)

Correspondence Address: Stattler-Suh PC, 60 SOUTH MARKET, SUITE 480, SAN JOSE, CA, 95113, US

(21) Appl. No.: 12/233,091

(22) Filed: Sep. 18, 2008

(51) Int. Cl. G06Q 10/00; G06Q 50/00

(52) U.S. Cl. 705/10

(57) ABSTRACT

A method and system are provided for targeting online ads using a social neighborhood of a social network. In one example, the method includes identifying a social neighborhood of the social network, calculating an adoption score for each consumer of the social neighborhood, wherein an adoption score is a ranking of a consumer in the social neighborhood according to a predicted number of consumer friends that will make an adoption at a future time, and then sending at least one ad to at least one consumer having a relatively high adoption score.

### FIELD OF THE INVENTION

The present invention relates to online advertising. More particularly, the present invention relates to targeting online ads using social neighborhoods of a social network.

### BACKGROUND OF THE INVENTION

Online networks, such as the Internet, connect a multitude of different consumers to an abundance of content. Just as the consumers are varied, the content is similarly varied in nature and type. In particular, the Internet provides a mechanism for merchants to offer a vast amount of products and services to consumers.

Leveraging social network information for ad targeting is becoming increasingly popular. Social Networks provide information about consumers that is not explicit in the behavior of individual consumers.

A key challenge with behavioral targeting is that it does not perform very well for consumers with little or no behavioral history, as in the case of new consumers or lightly engaged consumers. Social information can be highly useful in these cases where an ad system does not know much about the consumers but instead knows a lot about their social connections. Information about the consumers' social connections may be leveraged effectively to make predictions about the consumers' own interests. One important problem is how the ad system should effectively combine consumers' behavioral information with social information.

There are two main requirements for effective advertising in social networks. The first is that inks in the social network are relevant to the targeted ads. The second is that social information can be easily incorporated with existing targeting methods to predict response rates.

Effective advertising requires predicting how a consumer will respond to an ad. Typically, this means constructing a profile of consumers based largely on passive observation the interactions of the consumers with the network. Any predictions made from this profile are only the ad system's best guess as to what the consumer will do. Social networking sites allow consumers to declare their interest in products and to declare other consumers through social connections. Although consumers will explicitly tell the ad system their interests, it is still unclear how to relate these interests to predict response rates.

A key feature, required of social networks to be useful for advertising, is that people tend to share interests with their friends and tend to be friends with people who share their interests. This feature, known as homophily, has been shown in many social networks. To understand the presence and benefit of homophily, several questions are answered relevant to advertising on social networks: Do friends tend to see similar ads? Does having friends who responded to ads in the past influence a person to respond in the future? Do consumers who are similar tend to be friends?

Advertising is a key source of revenue for Internet companies like Yahoo!®. Identifying which ads should be shown to which consumers is a critical component of effective ad campaigns. Traditional ad targeting approaches have focused on leveraging consumer behavior and demographic/geographic information. The recent advances in online social networks have given rise to very rich social data that can be leveraged to improve ad targeting capabilities. Existing methods for social ad-targeting largely fall in two categories.

Targeting methods in the first category operate under an assumption that adoption through word-of-mouth spreads in a specific manner. For example, a targeting method may operate under the assumption that a consumer will adopt a service or purchase an item due to peer pressure when a fixed number (or fraction) of the consumer's friends adopt or purchase; such a targeting method falls under this first category.

Note that an adoption (i.e., a conversion) is substantially more than a mere click on (i.e., selection of) an online ad on a webpage. An adoption is proactive steps in furtherance of the purchase of an advertised product or service. An adopter is a consumer who adopts an advertised product or service. For example, an adopter may be a consumer that clicks on an ad for a cable service and then shortly thereafter goes on to buy the advertised cable service.

Targeting methods in the second category operate under an assumption of certain desirable traits for targeted consumers based on the marketer's gut feel, past experience, or common sense. For example, a targeting method may operate under the assumption that targeting consumers with most number of friends would be effective; such a targeting method falls under this second category. This targeting method focuses on marketing to consumers that are key influencers (i.e., consumers that tend to have a noticeable effect on how other consumers behave).

Both of these categories have problems. An advertiser cannot be sure whether the assumptions are actually pertinent to the specific social network and its characteristics. Also, an advertiser can never be sure if the seed set generated is the best target group the advertiser could get. Perhaps the most important problem is that these methods do not provide reliable targeting for an advertiser that wants to predict adopters. An adopter is a consumer who not only clicks (i.e., selects) an online ad but who also goes further to buy the advertised product or service. It has been found that individual consumers that are key influencers (i.e., consumers most likely to influence others to respond to an ad) do not reliably exist in a social network.

### SUMMARY OF THE INVENTION

What is needed is an improved method having features for addressing the problems mentioned above and new features not yet discussed. Broadly speaking, the present invention fills these needs by providing a method and system for targeting online ads using social neighborhoods of a social network. It should be appreciated that the present invention can be implemented in numerous ways, including as a method, a process, an apparatus, a system or a device. Inventive embodiments of the present invention are summarized below.

In one embodiment, a method is provided for targeting online ads using social neighborhoods of a social network. The method comprises identifying a social neighborhood of the social network and calculating an adoption score for each consumer of the social neighborhood, wherein an adoption score is a ranking of a consumer in the social neighborhood according to a predicted number of consumer friends that will make an adoption at a future time.

In another embodiment, a system is provided for targeting online ads using social neighborhoods of a social network. The system is configured for identifying a social neighborhood of the social network and calculating an adoption score for each consumer of the social neighborhood, wherein an adoption score is a ranking of a consumer in the social neighborhood according to a predicted number of consumer friends that will make an adoption at a future time.

In still another embodiment, a computer readable medium carrying one or more instructions for targeting online ads using a social neighborhood of a social network is provided. The one or more instructions, when executed by one or more processors, cause the one or more processors to perform the steps of identifying a social neighborhood of the social network and calculating an adoption score for each consumer of the social neighborhood, wherein an adoption score is a ranking of a consumer in the social neighborhood according to a predicted number of consumer friends that will make an adoption at a future time.

The invention encompasses other embodiments configured as set forth above and with other features and alternatives.

### BRIEF DESCRIPTION OF THE DRAWINGS

The present invention will be readily understood by the following detailed description in conjunction with the accompanying drawings. To facilitate this description, like reference numerals designate like structural elements.

FIG. 1 is a block diagram of a system for targeting online ads using social neighborhoods of a social network, in accordance with an embodiment of the present invention;

FIG. 2 is a schematic diagram of a simple social neighborhood, in accordance with an embodiment of the present invention; and

FIG. 3 is a flowchart of a method for targeting online ads using social neighborhoods of a social network, in accordance with an embodiment of the present invention.

### DETAILED DESCRIPTION OF THE INVENTION

An invention is disclosed for a method and system for targeting online ads using social neighborhoods of a social network. Numerous specific details are set forth in order to provide a thorough understanding of the present invention. It will be understood, however, to one skilled in the art, that the present invention may be practiced with other specific details.

### General Overview

A rich social network of a company like Yahoo!® provides a strategic resource that can be leveraged to improve ad targeting and consumer experience. It has been found that high premium service adoption rates in a social neighborhood (i.e., a group of socially interconnected consumers) positively correlate with certain behavioral attributes, demographic attributes, geographic attributes, and social attributes, among other attributes. Models based on these attributes allow prediction of future individual adopters and prime high-adoption-growth social neighborhoods. High-adoption-growth social neighborhoods are neighborhoods where consumers are adopting at a relatively high rate. In another embodiment, models based on the attributes discussed above allow prediction of future individual adopters and prime high-growth social neighborhoods. High-growth social neighborhoods are neighborhoods where consumers are adding new friends at a high rate, rather than adopting at a high rate.

The system here provides a method for isolating prime social neighborhoods by learning adoption behavior and social traits of the constituent consumers of those social neighborhoods. The system provides better adoption predictions than highly regarded heuristic-based selection methods (e.g., marketing to neighborhoods of highly connected consumers or to early adopters).

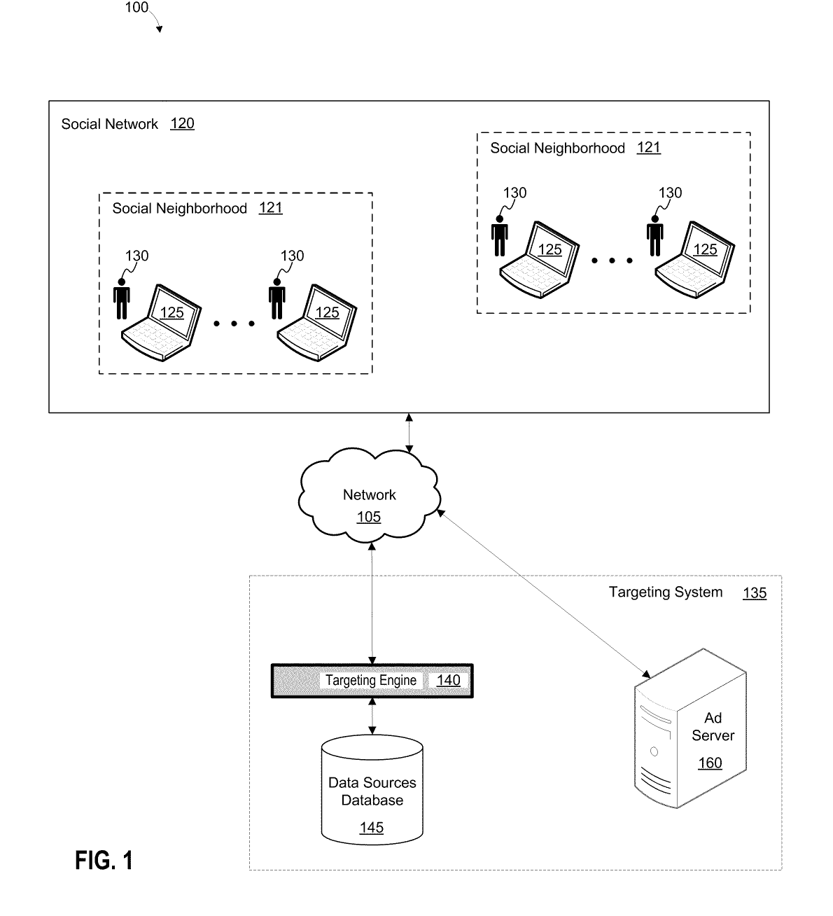

FIG. 1 is a block diagram of a system 100 for targeting online ads using social neighborhoods of a social network, in accordance with an embodiment of the present invention. The system 100 includes various devices that are coupled to each other. A device is hardware, software or a combination thereof. A device may sometimes be referred to as an apparatus. Each device is configured to carry out one or more steps of the method of targeting online ads using social neighborhoods of a social network.

The network 105 couples together a social network 120, a social network 120 a targeting engine 140 and an ad server 160. The network 105 may be any combination of networks, including without limitation the Internet, a local area network, a wide area network, a wireless network and a cellular network. The social network 120 includes without limitation one or more social neighborhoods 121. A social neighborhood 121 is a group of socially interconnected consumers 130. A social neighborhood may include without limitation a consumer, the consumer's immediately connected friends, friends of friends, and so on. A social neighborhood 121 includes without limitation two or more consumer computers 125. A consumer computer 125 may be a laptop, a desktop, a workstation a cell phone, a smart phone, a mobile device, a satellite phone, or any other computing apparatus. Consumers 130 operate the consumer computers 125.

The social network 120 may be coupled to a website, such as Yahoo!® IM (Instant Messenger), Yahoo!® Mail, Facebook.com, MySpace.com or Amazon.com, the website being configured to gather analytics about adoption behavior and social traits of the social network.

The targeting engine 140 and the ad server 160 are part of the targeting system 135. The targeting engine 140 is coupled to a data sources database 145. The targeting engine 140 may reside in an application server (not shown). In another embodiment, the targeting engine 140 may reside in the ad server 160. In still another embodiment, the targeting engine 140 may reside across a combination of computing apparatuses, including without limitation an application server, an ad server and/or a web server.

The targeting system 135 may carry out online processing as well as offline processing. The offline processing may include data analysis and processing of data in the data sources database 145. This offline processing may be carried out by the targeting engine 140 on a specialized application server (not shown). The specialized application server may later load the results of the processing onto the ad server 160.

The online processing may be carried out by the ad server 160 (or other server) monitoring adoption behavior of the consumers 130. The adoption behavior may be, for example, a consumer signing up for an advertised product or service (e.g., cable service). The ad server 160 may then trigger a message that will send emails or show ads to friends of that consumer 130 in the same social neighborhood 121. The ad server 160 may also send the monitored events to the targeting engine 140. The targeting engine 140 may use the monitored events for further fine tuning of the social neighborhoods 121.

Targeting Online Ads Using Social Neighborhoods The targeting system 135 is configured to learn from existing data in the data sources database 145. By learning the traits of consumers in various social neighborhoods 121 of the overall social network 120, the targeting system 135 is configured to predict adoptions within the entire social network 120. The targeting system 135 differs from conventional systems in that there are no a-priori assumptions about how word-of-mouth spreads through the social neighborhood 121 or about the kinds of consumers deemed desirable. On the contrary, by analyzing data of the data sources database 145, the targeting system 135 is configured to provide a better understanding of the mechanisms and consumer attributes governing ad adoption.

Identifying a Social Neighborhood

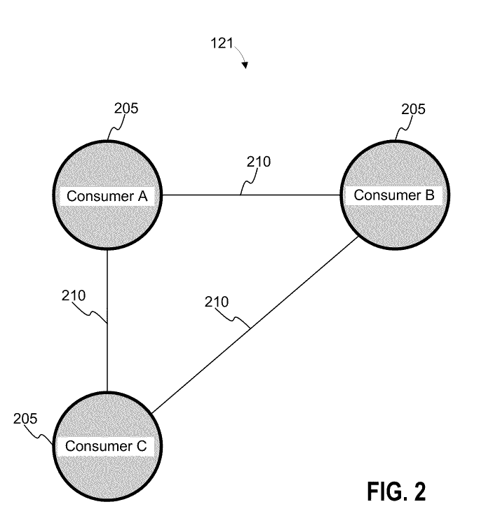

FIG. 2 is a schematic diagram of a simple social neighborhood 121, in accordance with an embodiment of the present invention. The targeting system 135 of FIG. 1 identifies a social neighborhood 121 as a group of socially interconnected consumers (i.e., a consumer and the consumer's immediately connected friends). For example, a social neighborhood 121 may refer to the consumers in Yahoo!® Instant Messenger as nodes 205 and may refer to their friendship connections as edges 210. For instance, consumer A, consumer B and consumer C may be Instant Messenger consumers. These connected consumers may have each-other in their friends lists. Accordingly, this particular social neighborhood 121 contains consumer A, consumer B and consumer C as nodes 205. There are edges 210 (i.e., connections) between the nodes 205.

Calculating Adoption Scores of Consumers in a Social Neighborhood

An adoption score is a ranking of each consumer relative to other consumers in a social neighborhood 121. In other words, an adoption score is a ranking of a consumer in the social neighborhood (i.e., the candidates for a marketing campaign) according to the predicted number of the consumer's friends that will adopt in the future. Consumers with more number of likely adopting friends appear earlier in the list. The adoption score is based on the number of the consumer's friends that have already adopted a product or service. To decrease the amount of computation required, the targeting system may consider only the existing adopters as candidates based on historical data. The targeting system may generalize to the whole consumer base if necessary. The whole consumer base includes all the consumers for which the targeting system has at least some social data. The whole consumer base may be the entire social network.

Referring to FIG. 1, the targeting system 135 considers offline data of the data source database 145, as well as online data from the ad server 160. The data source database 145 may include various consumer attributes, including without limitation social data, behavioral data, demographic data, and geographic data, among other consumer attributes.

Examples of social data include without limitation the number of friends in the consumer's friends list, and the number of friends that are linked to the consumer, among other social data.

Examples of behavioral data include without limitation the number of logins in the social neighborhood, the number of messages (e.g., Instant Messages) sent by consumer in a month, the average number of messages (e.g., Instant Messages) exchanged in the immediate circle of the consumer, the average number of logins in the social neighborhood, the number of web searches, the advertisement click rates, the favorite properties in the network, and the behavioral targeting category (e.g., automotive, finance, food & nutrition, parenting & children, telecommunications, travel, and health), among other behavioral data.

Examples of demographic data include without limitation the age of the consumer, the gender of consumer, the age of a friend (i.e., another consumer linked to the particular consumer), and the gender of a friend, among other demographic data.

Examples of geographic data include without limitation the IP (Internet Protocol) address of the consumer computer of the consumer, the physical address of the consumer, the country to which the consumer belongs, and the country to which a consumer's friend belongs, among other geographic data.

In calculating each adoption score, the targeting system also determines whether or not each consumer has adopted the particular product or service in question, or whether or note each consumer has already responded favorably to the ad campaign. For example, the targeting system may determine whether the consumer has already adopted a particular Internet phone service.

The targeting system may utilize any well-known machine learning algorithm to predict the number of future adoptions in the social neighborhood (i.e., immediate friends) of each candidate consumer. Examples of a well-known machine learning algorithm include without limitation a decision tree, a Support Vector Machine (SVM), and a logistic regression algorithm, among other algorithms. The targeting system makes predictions of future adoptions that are more accurate than random consumer selection and some highly regarded heuristics (e.g., selecting consumers with most friends or selecting the earliest adopters).

In another embodiment, the well-known machine learning algorithms are configured to incorporate any insights (e.g., the highly regarded heuristics) provided by domain experts (e.g., the sales force) or by human data analysis. Such a configuration is known to provide a further boost to machine learning performance. For example, domain experts (or data analysis) may lead explicitly to ignoring certain inputs to the machine learning (e.g., ignoring logins that did not overlap in time).

The targeting system may also be configured to utilize a credit-sharing device (not shown). The credit sharing device splits adoption credit among multiple predecessor friends of an adopter. Referring to FIG. 2, consider for example if consumer C and consumer B happen to have previously adopted a particular product. In such a case, the credit-sharing device would appropriately split the adoption credit between these friends with respect to consumer A. In a more complicated example, there may be layered steps of multiple consumers who adopted a particular product. In such a case, the credit-sharing device may appropriately divide the adoption credit amongst the adopters by assigning different amounts of the adoption credit amongst the adopters. The credit-sharing device operates on a case-by-case basis.

Sending Ads to Consumers with Highest Adoption Scores

The targeting system, described above, provides a social neighborhood targeting framework that identifies social neighborhoods that are ripe for advertising campaigns. The targeting system may then send ads (e.g., messages) to consumers with the highest adoption scores (e.g., the top 15% of consumers in a particular social neighborhood). Referring to FIG. 1, the ad server 160 of the targeting system may send the ads. One example of a message sent to a high scoring consumer is an email messaging saying, “Send this message to your friends and get 300 free cell phone minutes if 5 of your friends join.” Accordingly, the social neighborhoods model relies on current adopters to refer friends. The targeting system combines the effectiveness of social networks, behavioral data, and word-of-mouth advertising to provide a model that is complementary to the standard direct response targeting that is commonly in use.

The targeting system makes no a-priori assumptions about the mechanism governing word-of-mouth spread (or diffusion) needed. In other words, the way in which knowledge spreads about a particular product or service is not considered here. Given a real social network, it is often extremely difficult to ascertain whether a given diffusion rule is the best fit to the observed adoption behavior. The targeting system here does necessitate determining such rules. Indeed, the targeting system allows for better understanding of the underlying mechanisms of adoption by studying the learn model (i.e., the model that ultimately produces the adoption scores).

The targeting system does not need heuristic strategies (e.g., selecting consumers with most friends or selecting the earliest adopters). The targeting system learns a prediction model from data. Conventional wisdom dictates using highly connected consumers as seeds for viral marketing. In the absence of any other evidence (like previous responses of consumers in the graph or existing adoption data), using highly connected consumers may be a good idea. However, when additional behavioral information is available (the case considered here), the targeting system does better at predicting future adoptions. Indeed, the learning technique of the targeting system beats the heuristic of selecting highly connected consumers.

The social neighborhood strategy offers a complementary targeting strategy to a direct response targeting that are commonly in use by companies like Yahoo!®. A direct response marketing strategy typically identifies look-alikes of existing adopters. Social neighborhoods, on the other hand, enable finding potential adopters through social connections of existing adopters. The complementary approach would allow the targeting system to generate even more targeting inventory (i.e., consumers to target). Advertisers may leverage both strategies to maximize the impact of their marketing campaigns. Further, the social neighborhood strategy provides a means to start viral marketing campaigns. Prime social neighborhoods that have rich potential for adoption may be identified using the model based approach of the targeting system here. A viral spread can be initiated in these neighborhoods. Crowd sourcing the target selection and messaging to existing consumers, who presumably know their friends' interests better than the targeting system does, should improve adoption rates while minimizing the amount of messaging and thus improving consumer experience.

The targeting system may compare the actual future adoptions from targeting the same sizes of targeted consumer pools using the two different strategies discussed above (i.e., direct marketing and social neighborhood). Marketers may then estimate the total cost and expected conversions for the two strategies and make an informed cost-benefit trade-off.

The targeting system is configured to predict that many friends of highly-ranked candidates are likely to adopt. Accordingly, a direct targeting strategy may piggy-back on these outputs, wherein friends of such consumers are directly targeted. Such piggy-backing provides an additional pool of targeted consumers for larger ad campaigns.

The targeting system may contribute to viral marketing. The targeting is configured to embody the idea that social neighborhoods that are already rich in adoption will continue to adopt. Accordingly, there is a possibility of triggering a percolation of adoptions, where conversion of multiple consumers in the same social neighborhood starts off a chain reaction of adoptions. The targeting system may be configured to learn and predict the proper number of consumers to target in a social neighborhood for triggering such chain reactions.

### Method Outline

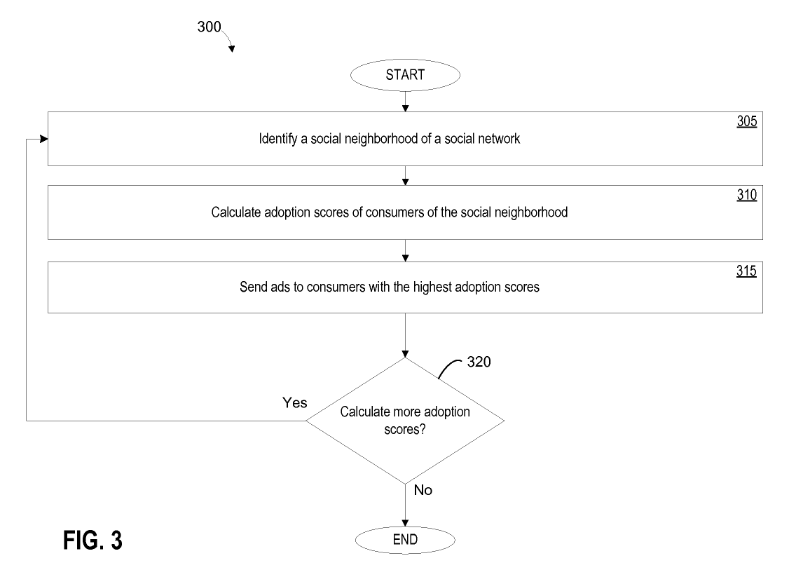

FIG. 3 is a flowchart of a method 300 for targeting online ads using social neighborhoods of a social network, in accordance with an embodiment of the present invention. The targeting system 135 of FIG. 1 may be configured to carry out the steps of the method 300. Details of the method 300 are discussed above with reference to FIG. 1 and FIG. 2. The method 300 starts in step 305 where the system identifies a social neighborhood of a social network. The method 300 then moves to step 310 where the system calculates adoptions scores of consumers of the social neighborhood. Next, in step 315, the system sends ads to consumers with the highest adoption scores. The method 300 then proceeds to decision operation 320 where the system determines if there are more adoption scores to be calculated. If the system determines that there are more adoption scores to be calculated, the method 300 returns to step 305 and continues. However, if the system determines that there are no more adoption scores to be calculated, the method 300 is at an end.

### Computer Readable Medium Implementation

Portions of the present invention may be conveniently implemented using a conventional general purpose or a specialized digital computer or microprocessor programmed according to the teachings of the present disclosure, as will be apparent to those skilled in the computer art.

Appropriate software coding can readily be prepared by skilled programmers based on the teachings of the present disclosure, as will be apparent to those skilled in the software art. The invention may also be implemented by the preparation of application-specific integrated circuits or by interconnecting an appropriate network of conventional component circuits, as will be readily apparent to those skilled in the art.

The present invention includes a computer program product which is a storage medium (media) having instructions stored thereon/in which can be used to control, or cause, a computer to perform any of the processes of the present invention. The storage medium can include, but is not limited to, any type of disk including floppy disks, mini disks (MD's), optical disks, DVDs, CD-ROMs, micro-drives, and magneto-optical disks, ROMS, RAMs, EPROMS, EEPROMS, DRAMs, VRAMs, flash memory devices (including flash cards), magnetic or optical cards, nanosystems (including molecular memory ICs), RAID devices, remote data storage/archive/warehousing, or any type of media or device suitable for storing instructions and/or data.

Stored on any one of the computer readable medium (media), the present invention includes software for controlling both the hardware of the general purpose/specialized computer or microprocessor, and for enabling the computer or microprocessor to interact with a human consumer or other mechanism utilizing the results of the present invention. Such software may include, but is not limited to, device drivers, operating systems, and consumer applications. Ultimately, such computer readable media further includes software for performing the present invention, as described above.

Included in the programming (software) of the general/specialized computer or microprocessor are software modules for implementing the teachings of the present invention, including without limitation identifying a social neighborhood of the social network, calculating an adoption score for each consumer of the social neighborhood, and sending at least one ad to at least one consumer having a relatively high adoption score, according to processes of the present invention.

### Advantages

The targeting system provides a social neighborhood targeting framework that identifies social neighborhoods that are ripe for advertising campaigns. The targeting system is not configured to take into account key influencers because key influencers do not reliably exist in a social network.

The targeting system targets consumers with the highest adoption scores (e.g., the top 15% of consumers in a particular social neighborhood). The targeting system makes no a-priori assumptions about the mechanism governing word-of-mouth spread (or diffusion) needed. The targeting system does not need heuristic strategies (e.g., selecting consumers with most friends or selecting the earliest adopters). The social neighborhood strategy offers a complementary targeting strategy to a direct response targeting that may in use extensively by a company like Yahoo!®. The targeting system may compare the actual future adoptions from targeting the same sizes of targeted consumer pools using the two different strategies (i.e., direct marketing and social neighborhood). The targeting system is configured to predict that many friends of highly-ranked candidates are likely to adopt. Also, the targeting system may contribute to viral marketing.

In the foregoing specification, the invention has been described with reference to specific embodiments thereof. It will, however, be evident that various modifications and changes may be made thereto without departing from the broader spirit and scope of the invention. The specification and drawings are, accordingly, to be regarded in an illustrative rather than a restrictive sense.

What is claimed is:

1. A method for targeting online ads using social neighborhoods of a social network, the method comprising:
identifying a social neighborhood of the social network; and
calculating an adoption score for each consumer of the social neighborhood, wherein an adoption score is a ranking of a consumer in the social neighborhood according to a predicted number of consumer friends that will make an adoption at a future time.

2. The method of claim 1, further comprising sending at least one ad to at least one consumer having a relatively high adoption score.

3. The method of claim 1, wherein identifying the social neighborhood comprises identifying a group of socially interconnected consumers.

4. The method of claim 1, wherein calculating an adoption score for each consumer comprises considering at least one of:
social data;
behavioral data;
demographic data; and
geographic data.

5. The method of claim 4, wherein the social data comprises at least one of:
a number of friends in a friends list of a consumer; and
a number of friends that are linked to a consumer.

6. The method of claim 4, wherein the behavioral data comprises at least one of:
a number of logins of a consumer;
a number of messages sent by a consumer;
an average number of messages exchanged in an immediate circle of a consumer;
an average number of logins in the social neighborhood;
a number of web searches of a consumer;
an advertisement click rate of a consumer;
favorite properties of a consumer; and
a behavioral targeting category of a consumer.

7. The method of claim 4, wherein the demographic data comprises at least one of:
an age of a consumer;
a gender of a consumer;
an age of a friend of a consumer; and
a gender of a friend of a consumer.

8. The method of claim 4, wherein the geographic data comprises at least one of:
an IP address of a consumer computer;
a physical address of a consumer;
a country to which a consumer belongs; and
a country to which a friend of a consumer belongs.

9. The method of claim 1, wherein calculating an adoption score for each consumer comprises determining whether a consumer has at least one of:
adopted a particular product;
adopted a particular service; and
responded favorably to a particular ad campaign.

10. The method of claim 1, wherein calculating an adoption score comprises utilizing a credit-sharing device configured for dividing adoption credit among multiple friends of a particular consumer, where each of the multiple friends previously made an adoption before the particular consumer made an adoption.

11. A system for targeting online ads using social neighborhoods of a social network, wherein the system is configured for:
identifying a social neighborhood of the social network; and
calculating an adoption score for each consumer of the social neighborhood, wherein an adoption score is a ranking of a consumer in the social neighborhood according to a predicted number of consumer friends that will make an adoption at a future time.

12. The system of claim 11, wherein the system is further configured for sending at least one ad to at least one consumer having a relatively high adoption score.

13. The system of claim 11, wherein identifying the social neighborhood further configures the system for identifying a group of socially interconnected consumers.

14. The system of claim 11, wherein calculating an adoption score for each consumer further configures the system for considering at least one of:
social data;
behavioral data;
demographic data; and
geographic data.

15. The system of claim 14, wherein the social data comprises at least one of:
a number of friends in a friends list of a consumer; and
a number of friends that are linked to a consumer.

16. The system of claim 14, wherein the behavioral data comprises at least one of:
a number of logins of a consumer;
a number of messages sent by a consumer;
an average number of messages exchanged in an immediate circle of a consumer;
an average number of logins in the social neighborhood;
a number of web searches of a consumer;
an advertisement click rate of a consumer;
favorite properties of a consumer; and
a behavioral targeting category of a consumer.

17. The system of claim 14, wherein the demographic data comprises at least one of:
an age of a consumer;
a gender of a consumer;
an age of a friend of a consumer; and
a gender of a friend of a consumer.

18. The system of claim 14, wherein the geographic data comprises at least one of:
an IP address of a consumer computer;
a physical address of a consumer;
a country to which a consumer belongs; and
a country to which a friend of a consumer belongs.

19. The system of claim 11, wherein calculating an adoption score for each consumer further configures the system for determining whether a consumer has at least one of:
adopted a particular product;
adopted a particular service; and
responded favorably to a particular ad campaign.

20. The system of claim 11, wherein calculating an adoption score further configures the system for utilizing a credit-sharing device configured for dividing adoption credit among multiple friends of a particular consumer, where each of the multiple friends previously made an adoption before the particular consumer made an adoption.

21. A computer readable medium carrying one or more instructions for targeting online ads using a social neighborhood of a social network, wherein the one or more instructions, when executed by one or more processors, cause the one or more processors to perform the steps of:
identifying a social neighborhood of the social network; and
calculating an adoption score for each consumer of the social neighborhood, wherein an adoption score is a ranking of a consumer in the social neighborhood according to a predicted number of consumer friends that will make an adoption at a future time.
